(19) United States
(12) Patent Application Publication
(10) Pub. No.: US 2015/0321837 A1
(43) Pub. Date: Nov. 12, 2015

(54) CONTAINER HAVING DISPENSING OUTLET PREVENTING COLLECTION OF RESIDUAL MATERIAL

(71) Applicant: Buckhorn, Inc., Milford, OH (US)

(72) Inventor: Daniel R. MILLER, Hamilton, OH (US)

(21) Appl. No.: 14/704,253

(22) Filed: May 5, 2015

Related U.S. Application Data
(60) Provisional application No. 61/989,205, filed on May 6, 2014.

(51) Int. Cl. B65D 88/54; B65D 88/28; A01C 7/20; B65D 47/40

(52) U.S. Cl. CPC B65D 88/54; B65D 47/40; B65D 88/28; A01C 7/20

(57) ABSTRACT

A container, that is usable for dispensing flowable materials, includes angled bottom walls which direct the flowable material to a dispensing opening. A flow cutoff device is supported, for movement between open and closed positions, in a frame assembly which defines the dispensing opening. A shield plate prevents any of the flowable material from being trapped in residual flowable material receiving areas that are adjacent the frame assembly at the outlet opening of the container. Openings are provided in an end rail of the frame assembly and also at the juncture of the end rail with spaced side rails of the frame assembly. These openings provide egress areas for any of the flowable material that might be supported by the side rails and the end rail as the cutoff device is slid along the frame assembly to the flow cutoff position.

### CROSS REFERENCE TO RELATED APPLICATIONS

This application claims priority to U.S. provisional patent application No. 61/989,205 filed May 6, 2014, the disclosures of which are expressly incorporated herein by reference.

### FIELD OF THE INVENTION

The present invention is directed generally to a container for dispensing a flowable material through a dispensing outlet. The dispensing outlet prevents the collection of residual flowable material adjacent the outlet. A shield plate is positioned to prevent this collection of the residual flowable material adjacent the outlet of the container.

### BACKGROUND OF THE INVENTION

Bulk boxes and containers having collapsible side and end walls are frequently used for holding and dispensing flowable materials such as agricultural products including seeds for planting. The interior of the box or container has angled bottom walls that direct the flowable material to a dispensing outlet. After delivery and dispensing of the flowable material, the sides of the box or container are collapsed and the box or container is reduced in size for efficient return handling of the now empty container. The container is thus able to be used for several planting seasons to transport and to dispense flowable materials, such as soybeans or corn.

In use, such a collapsible container may contain the soybean or corn and is usable for transporting the soybean or corn to an end user who dispenses the soybean, corn or other flowable material from the container. Upon visual inspection, the soybean, corn or other flowable material may appear to have been completely dispensed from the container and the container is returned in its presumed empty condition for re-use. In a subsequent use, a different seed or flowable material may be transported in the same box or container and will be dispensed through the dispensing outlet of the container to an end user. However, the dispensing outlets of generally known prior dispensing containers have areas adjacent the dispensing outlet which are susceptible to collecting residual amounts of the flowable material which may include a residual amount of a different seed which was stored and dispensed in a previous use of the container. Any such residual seed which remains collected adjacent the outlet of the container has a potential for contaminating the seed placed in the container in the subsequent use of the container, particularly when the seed being contained and dispensed changes from one use of the container to the next use of that container.

A bulk box or container for use in dispensing a flowable material and having an outlet at the base of the container through which the flowable material is dispensed, is shown in U.S. Pat. No. 6,010,022. The dispensing outlet of that container is provided with a cutoff device that cuts off the flow of the flowable material through the dispensing outlet. However, the dispensing outlet is subject to the collection of the residual flowable material in areas at the outlet of the dispensing container that are not visible upon inspection of the interior of the container. As a result, a user of the container may observe that the container is completely empty but may not be able to observe that residual flowable material has collected in areas adjacent the outlet of the container. This presents a potential contamination problem for subsequent users of the container in the storage and dispensing of seeds for planting.

### BRIEF SUMMARY OF THE INVENTION

Containers for storing, shipping and dispensing a flowable material are widely used particularly in the agricultural industry in which the flowable material is a seed used for planting. An individual container is subject to being used for different seed products which are dispensed through the outlet in the bottom of the container. The dispensing of the seed through the outlet of such a container is controlled by a cutoff device. According to embodiments of the present invention, the cutoff device at the outlet of the dispensing container is usable to close and open the dispensing outlet without the collection of residual seed adjacent the outlet of the container, which residual seed might otherwise cause a contamination problem when the container is used for storing, shipping and dispensing seed over many use cycles in which different seed products are used as the flowable material placed in the container.

According to embodiments of the present invention, the cutoff device that controls the flow of the flowable material through the dispensing outlet prevents the collection of residual material at the dispensing outlet. The container is thus able to be used for storing, shipping and dispensing of flowable materials, such as different types of seed, for many cycles of use without contaminating the seed placed in the container with residual seed which may have collected from previous uses of the same container.

### BRIEF DESCRIPTION OF THE DRAWINGS

A full and complete understanding of the subject invention may be obtained from the description of the preferred embodiments, as set forth hereinafter, and as depicted in the accompanying drawings, in which:

FIG. 1 is a partial sectional view through a side of a bulk container for dispensing flowable materials according to the prior art;

FIG. 2 is a partial sectional view through an end wall of the prior art dispensing bulk container shown in FIG. 1;

FIG. 3 is a partial bottom plan view of the prior art dispensing bulk container shown in FIGS. 1 and 2;

FIG. 4 is a partial sectional view, generally similar to FIG. 2, and showing a frame assembly at the outlet of a container in accordance with the first embodiment of the present invention;

FIG. 5 is a perspective view of a top of a frame assembly for an outlet of a container for dispensing a flowable material according to the first embodiment of the present invention;

FIG. 6 is a perspective bottom view of the frame assembly shown in FIG. 5.

FIG. 7 is a second bottom perspective view of the frame assembly shown in FIG. 6;

FIG. 8 is a bottom perspective view of an end rail of the frame assembly shown in FIG. 5;

FIG. 9 is a bottom perspective view of a side rail of the frame assembly shown in FIG. 5;

FIG. 10 is a frame assembly of a cutoff device in top perspective view in accordance with a second preferred embodiment of the present invention;

FIG. 11 is a bottom perspective view of the frame assembly for the outlet of the dispensing container according to the second embodiment as shown in FIG. 10;

FIG. 12 is a perspective view of a shield part of the frame assembly shown in FIGS. 5 and 10 according to the first and second embodiments of the present invention;

FIG. 13 is a top perspective view of the frame of the second embodiment of the present invention shown and with the shield part removed; and

FIG. 14 is a bottom perspective view of the frame assembly of the second embodiment of the present invention, as shown in FIG. 10, and without the shield part.

### DESCRIPTION OF THE PREFERRED EMBODIMENTS

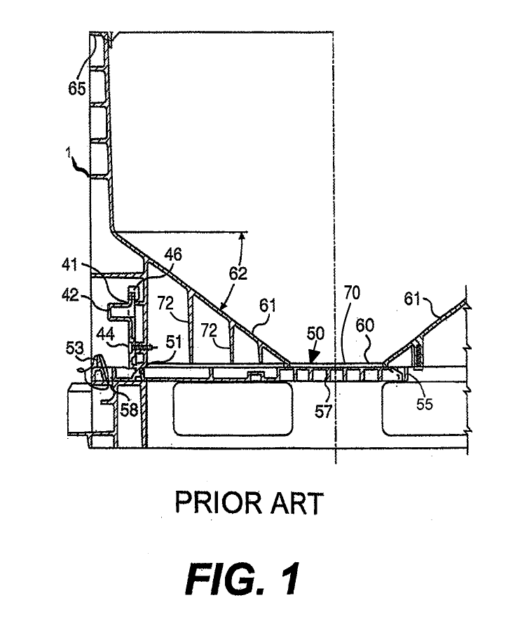

Referring initially to FIG. 1, there is shown a partial sectional view of a dispensing container 1 for flowable material according to U.S. Pat. No. 6,010,022, the disclosure of which is expressly incorporated herein by reference. The partial sectional side view is taken through a side wall of a container 1 with container 1 having a container bottom wall 61 which is sloped downwardly from the horizontal at an angle 62 to promote the flowable material stored in the container to be gravity fed through a container dispensing outlet 60. Dispensing of the flowable material is controlled by a cutoff device 50 which slides across the bottom of the dispensing outlet 60 to either open or block the outlet. As shown in FIGS. 1-3, the cutoff device 50 may be of a molded resin configuration having ribs 57 that extend across the bottom of the cutoff device 50 and which provide structural support for the cutoff device 50. That cutoff device 50 has a top surface 70 that forms a bottom wall across the container dispensing outlet 60 when the cutoff device 50 is in the closed position, as is shown in FIG. 1.

FIG. 1 shows the cutoff device 50 in a closed position. A locking arm 41, which can be rotated by a knob 42 about a pivot axis 44, such as a screw, is depicted in a position to engage a flange 51 of the cutoff device 50. The cutoff device 50 is further shown secured in its closed position by a security tie 53 which passes through an opening 58 in the base of the container 1 to ensure that the cutoff device 50 will not be inadvertently opened until the container, which is full of the flowable material, is delivered to a end user for subsequent dispensing of the flowable material through the outlet 60.

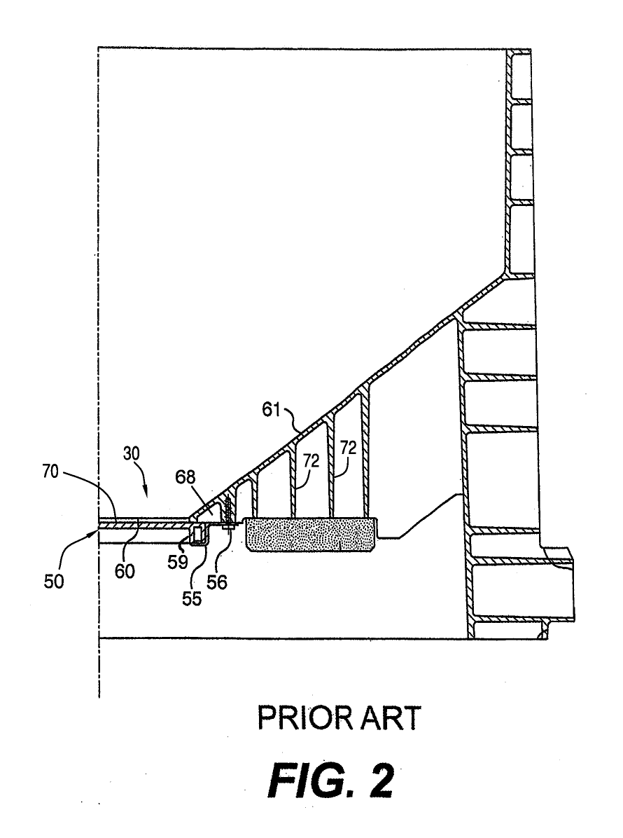

As shown in FIG. 2, which is an enlarged partial sectional view through an end wall of the container shown in FIG. 1, the cutoff device 50 is supported along its sides 59 by a frame assembly 30 that includes frame assembly side tracks 55 which are secured by frame assembly securement screws 56 to the bottom of sloped wall 61 of the container 1, with only one side of container 1 being shown in FIG. 2. As is also shown in FIG. 2, the bottom sloped wall 61 of container 1 is angled to the container dispensing outlet 60 and has structural ribs 72 which are provided to support the angled bottom of sloped wall 61. As a result of this structure, pockets are formed in the sloped bottom wall 61 adjacent the container dispensing outlet 60. The frame assembly side track 55, and a frame assembly end rail, partially cover the pockets 68.

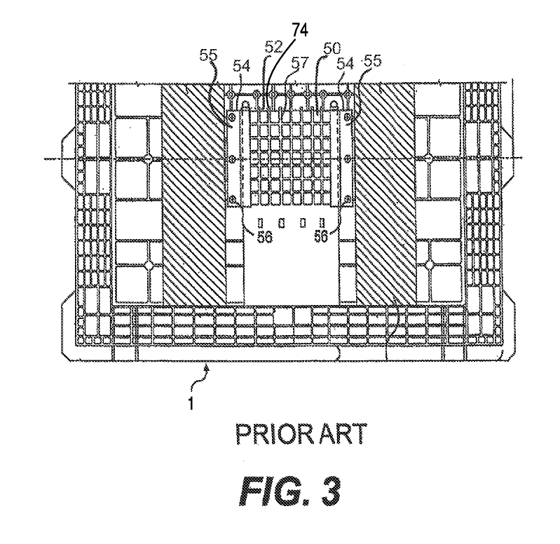

FIG. 3 shows a bottom plan view of a base portion of the container 1. The frame assembly side tracks or rails 55 support the sides 59 of the cutoff device. Note that an end rail 55, which is located in front of the discharge door, is not specifically shown in FIG. 3. The open areas 54 are provided at the ends of the rails 55. When the cutoff device 50 slides in the rails 55 and opens the container dispensing outlet 60, seed or other flowable material pours through the outlet 60 and through the bottom of the container 1 for dispensing. At the time of this flowable material dispensing, some of the flowable material may spill onto the tracks or rails 55 and may further accumulate in the open pockets 68. Thus, when the cutoff device 50 is closed, leading edges 74 of the cutoff device ribs 57 force the seed up into the pockets 68 and also into the end rail of the frame assembly 30 supporting the cutoff device, if provided.

In the prior art container 1, having a dispensing outlet 60 for flowable material, as shown in FIGS. 1-3, the cutoff device 50 is supported in the outlet frame assembly 30 for the container, which outlet frame assembly 30 is susceptible to collecting residual flowable material in the pockets 68 between the flanges of the cutoff device 50 above and along the rails 55 supporting the cutoff device 50. In the case where the flowable material is a seed, such as soybean or corn, one use of the container for soybean can cause the collection of residual soybean seed in the corner pockets 68 and along the rails 55 and including the end rail of the frame assembly 30 supporting the cutoff device 50. Then, during a subsequent use of the container for the dispensing of a flowable material, such as a different seed from that of the previous use, there is a risk of contamination by inadvertently dispensing the residual seed that has collected in the pockets formed adjacent the container dispensing outlet 60 from the prior use, which contamination is disadvantageous for the end user.

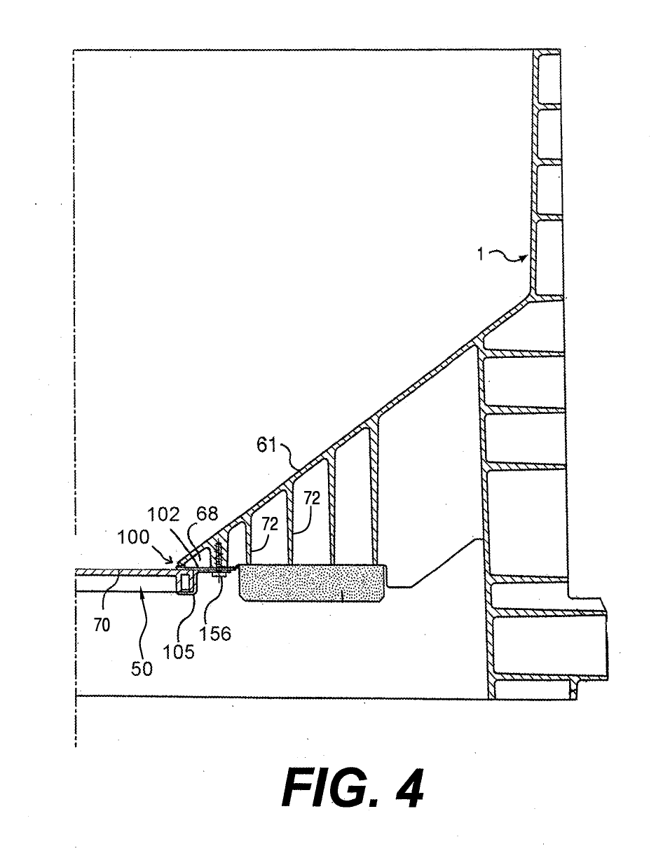

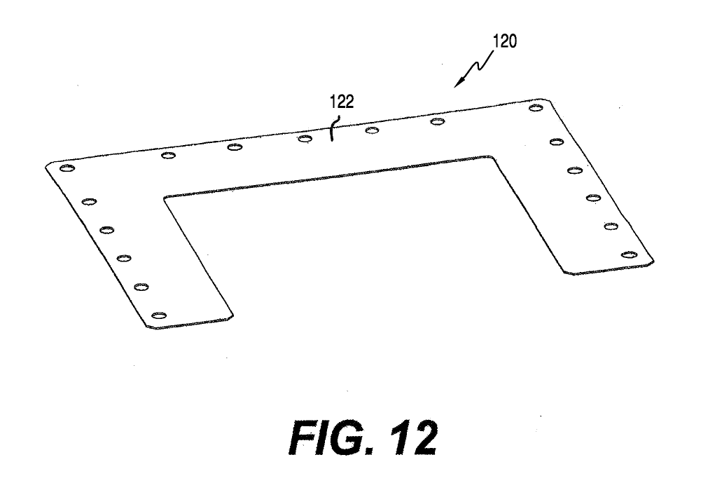

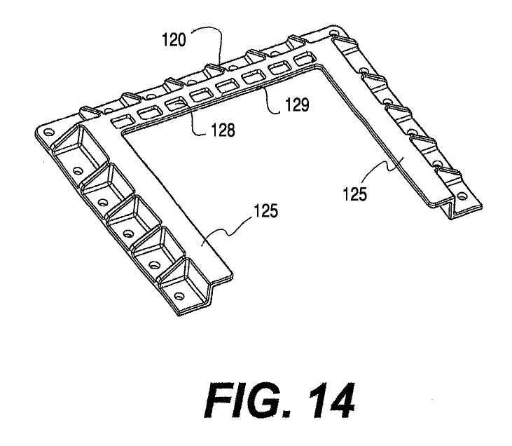

According to the embodiments of the present invention, as shown in FIGS. 4-14, a frame assembly 100 has a frame assembly shield plate 102 covering the pockets 68 along frame assembly side and/or end rails 105; 108, respectively. FIG. 4 shows a frame assembly 100 in accordance with the first embodiment of the present invention and including the side rail 105 beneath the pockets 68. In accordance with the present invention, the shield plate 102 closes off the open area of the pockets along the side rails 105 and/or end rail 108 so that the use of the cutoff device 50 does not cause the flowable material stored in the container 1 to be collected in the pockets 68. Thus, the collection of residual flowable material, such as seed, is prevented from being collected in pockets 68 at the outlet 60 of the container 1.

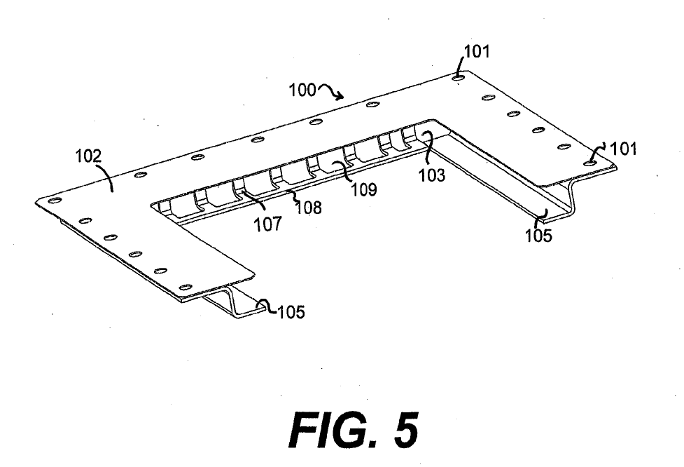

FIG. 5 shows an embodiment, according to the present invention, of a frame assembly 100 for supporting cutoff device 50, which cutoff device 50 is not specifically shown in FIG. 5. The frame assembly shield plate 102 may be separate from a frame part or may be integral with the frame part which includes frame assembly side rails 105 and a frame assembly end rail 108. The frame assembly end rail 108 supports a leading edge 52 of the cutoff device 50 and has openings 109 between spaced flange parts 107 of the frame assembly 100. The spaced flange parts 107 of the frame assembly 100 are aligned with the ribs 57 of the cutoff device 50. As the cutoff device 50 slides, to close off the dispensing outlet 60, which is defined by the side rails 105, and the end rail 108 of the frame assembly 100, the leading edge 52 of the cutoff device 50 pushes any residual flowable material off of the surfaces of the side rails 105 and into open areas 103 which are formed between the spaced frame assembly 105 and the end rail 108. These openings 103 are located at the ends of the frame assembly side rails 105. Further, any flowable material which might be supported along the surface of the frame assembly end rail 108 is pushed off through the openings 109, and since the ends 74 of the ribs 57 of the cutoff device 50 are aligned with the flanges 107, all of the flowable material is prevented from being collected along the support surfaces of the cutoff device frame assembly 100 and therefore the dispensing outlet 60 of the container 1 is prevented from collecting residual material dispensed through the dispensing outlet 60.

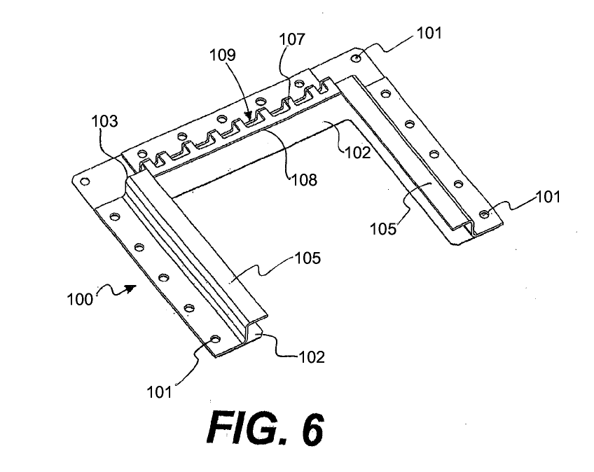

FIG. 6 is a bottom view of the frame assembly 100 of FIG. 5. As shown in FIGS. 4, 5 and 6, the frame assembly 100 is secured to the bottom wall of the container 1 with screws 156, which screws 156 are inserted through spaced screw receiving holes 101. The screw receiving holes 101 are provided in the frame assembly shield plate 102 and in underlying portions of the frame assembly 100 so that the frame assembly 100 and the frame assembly shield plate 102 are assembled together at the outlet of the container 1.

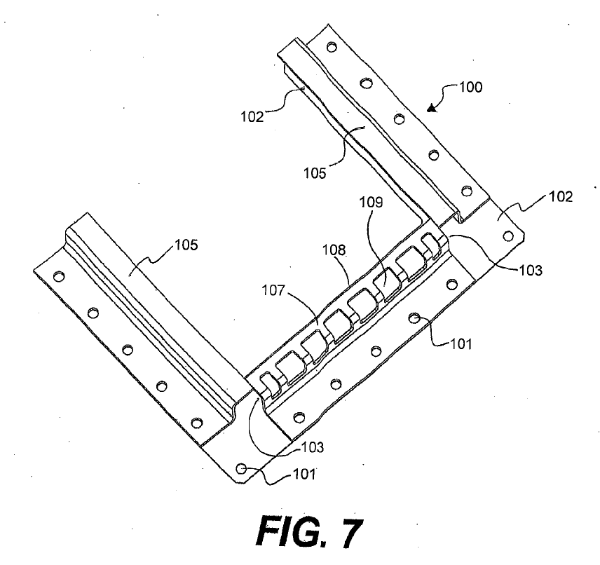

FIG. 7 shows a bottom view including a detail of the openings 109 and the spaced flange parts 107 of the frame assembly end rail 108. Also, the open area 103 beneath the shield is shown, which open area 103 assists in ensuring that seed is pushed off the ends of the side rails 105 when the cutoff device 50 closes the dispensing outlet 60.

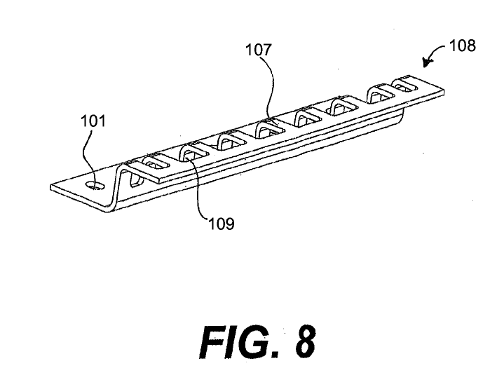

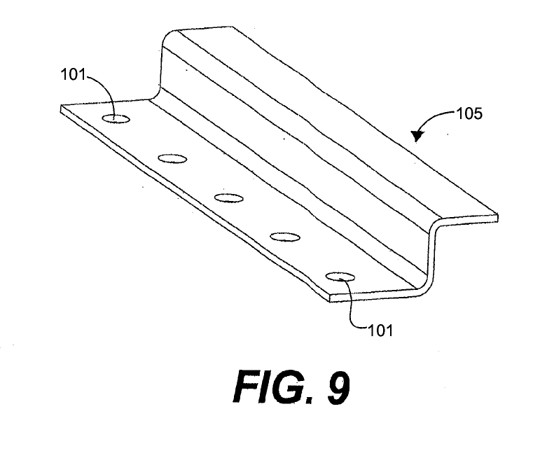

In one embodiment of the present invention, the frame assembly, generally at 100, includes a separately manufactured frame assembly end rail 108 as shown in FIG. 8 and separately manufactured frame assembly side rails 105, as shown in FIG. 9. The frame assembly side rails 105 and end rail 108 are able to be secured together to form the frame assembly 100, which is shown in FIGS. 5 and 6, by use of known fastening techniques, such as welding or mechanical fastening, such as, for example, the screws 156 which secure the frame assembly 100 to the bottom of the container 1, as seen in FIG. 4.

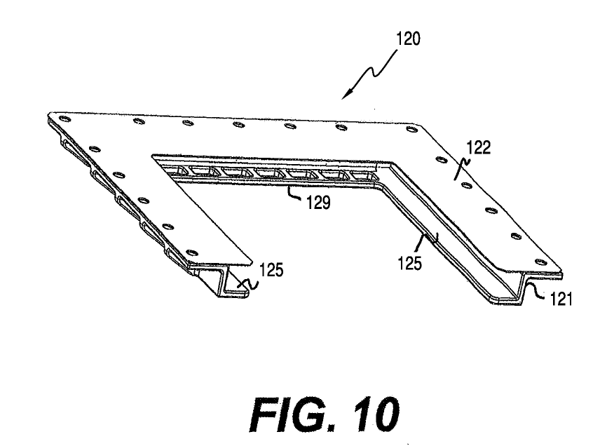

FIGS. 10-14 show a second embodiment of a frame assembly, generally at 120, according to the present invention. The frame assembly 100 shown in FIGS. 5-9, may be manufactured from sheet metal. The frame assembly 120 of FIGS. 10-14 is able to be manufactured from a different material such as a synthetic resin, for example, as a molded product.

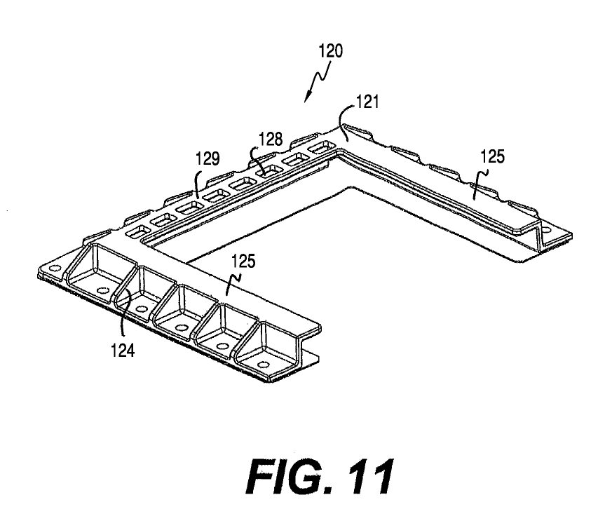

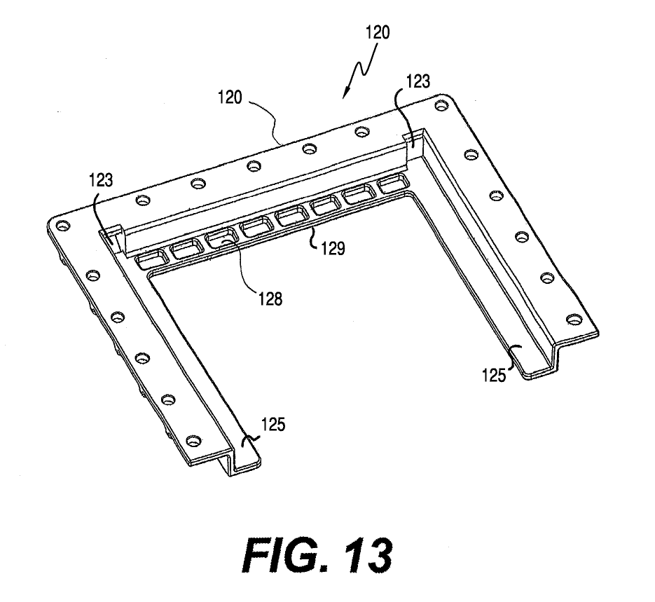

FIG. 10 shows a frame assembly 120 including a frame assembly part 121 of unitary molded construction, which may be fabricated from synthetic resin, and a shield plate which is aligned with the frame assembly part 121. The frame assembly 120 includes frame assembly side rails 125 and a frame assembly end rail 129. As shown in FIG. 11, the frame assembly part 121 includes structural ribs 124 for supporting the frame assembly side and end rails 125; 129, respectively. Also, FIG. 11 and FIGS. 13 and 14 show openings 128 in frame assembly end rail 129. The openings 128 provide the same function as the openings 109 and align with the ends 74 of the ribs 57 of the cutoff device 50 so that any seed resting on the end rail 129 is pushed into the openings 128 and is discharged so that seed is not collected as a residual flowable material. Also, the open areas 123, as shown in FIG. 13, are provided at the ends of the side rails 125 in order to push any flowable material resting on side rails 125 and end rail 129 into the open areas 123 thereby preventing the collection of residual material.

While preferred embodiments of a container having dispensing outlets for preventing collection of residual material, in accordance with the present invention, have been set forth fully and completely hereinabove, it will be apparent to one of skill in the art that various changes, for example the type of material used to manufacture the container, the overall shape of the container, the method of collapsing of the container, and the like could be made without departing from the true spirit and scope of the present invention, which is accordingly to be limited only by the appended claims.

What is claimed is:

1. A container for dispensing flowable materials, the container comprising:
spaced side walls and end walls;
angled bottom walls connected to the spaced side walls and end walls;
an outlet opening defined by the angled bottom walls;
a frame assembly defining the outlet opening and including spaced side rails and an end rail;
a flow cutoff device slidably supported by the side rails and end rail of the frame assembly, and movable between an open, flow enabling position and a closed, flow blocking position;
at least one residual flow material receiving area adjacent the frame assembly; and
a shield plate intermediate the frame assembly and the at least one residual flow material receiving area, the shield plate preventing accumulation of flowable material in the at least one residual flowable material receiving area.

2. The container for dispensing flowable materials in accordance with claim 1 further including at least one opening in the end rail, the at least one opening providing a first egress area for flowable material supported on the side rails during movement of the cutoff device to its closed, flow blocking position.

3. The container for dispensing flowable materials in accordance with claim 2, further including at least one open area at a juncture of one of the side rails and the end rail, the open area providing a second egress area for the flowable material during movement of the cutoff device to its closed, flow blocking position.

4. The container for dispensing flowable materials in accordance with claim 2 wherein there are a plurality of spaced ones of the openings in the end rail.

5. The container for dispensing flowable materials in accordance with claim 1 wherein the shield plate overlies each of the spaced side rails.

6. The container for dispensing flowable materials in accordance with claim 1 further including spaced ribs at the bottom of the angled bottom walls, the at least one residual flowable material receiving area being defined by the angled bottom walls of the container and spaces between the spaced ribs.

7. The container for dispensing flowable materials in accordance with claim 5 wherein the shield plate is secured between the container bottom wall and the spaced side rails of the frame assembly during attachment of the frame assembly around the outlet opening.

8. The container for dispensing flowable materials in accordance with claim 4 wherein the cutoff device includes a plurality of reinforced ribs having reinforcing rib ends each aligned with a spaced flange part of the end rail intermediate spaced ones of the end rail openings.

9. The container for dispensing flowable materials in accordance with claim 7 including screws securing the shield plate, side rails and end rail to the angled bottom walls of the container adjacent the outlet opening.

10. The container for dispensing flowable materials in accordance with claim 1 wherein the shield plate is integral with each of the side rails.

11. The container for dispensing flowable materials in accordance with claim 1 wherein the shield plate is separate from each of the side rails.

12. The container for dispensing flowable materials in accordance with claim 1 wherein the frame assembly and the shield assembly are metal.

13. The container for dispensing flowable materials in accordance with claim 1 wherein the frame assembly and the shield plate are a resin material.

14. The container for dispensing flowable materials in accordance with claim 1 wherein the side walls and the end walls of the container are collapsible.
